(19) United States
(12) Patent Application Publication
(10) Pub. No.: US 2015/0277379 A1
(43) Pub. Date: Oct. 1, 2015

(54) APPARATUS AND METHOD FOR ESTIMATING POSITION OF HOLOGRAM OBJECT

(71) Applicant: ELECTRONICS AND TELECOMMUNICATIONS RESEARCH INSTITUTE, Daejeon (KR)

(72) Inventor: Seung Taik OH, Seoul (KR)

(21) Appl. No.: 14/468,811

(22) Filed: Aug. 26, 2014

(30) Foreign Application Priority Data
Mar. 28, 2014 (KR) 10-2014-0036818

(51) Int. Cl. G03H 1/22

(52) U.S. Cl. CPC G03H 1/2202; G03H 2001/2244

(57) ABSTRACT

Provided are a hologram object position estimating apparatus and method for estimating a position of an object recorded in a hologram at a high speed using only light wave information recorded in the hologram. The apparatus for estimating a position of a hologram object includes a local spatial frequency calculating unit configured to calculate a local spatial frequency on a plane based on input hologram data, and a light ray focal point calculating unit configured to calculate a focal point on which light rays starting from the hologram plane converge on a hologram plane using the local spatial frequency calculated by the local spatial frequency calculating unit to estimate a position of an object.

### CROSS-REFERENCE TO RELATED APPLICATIONS

This application claims priority under 35 U.S.C. §119 to Korean Patent Application No. 10-2014-0036818, filed on Mar. 28, 2014, the disclosure of which is incorporated herein by reference in its entirety.

### TECHNICAL FIELD

The present invention relates to an apparatus and method for estimating a position of a hologram object, and more particularly, for estimating a position of an object recorded in a hologram at a high speed using only light wave information on the hologram.

### BACKGROUND

In general, when a computer-generated hologram is given without any information regarding a recorded object, the easiest way to know what kind of object has been recorded may be recognizing recorded object information through numerical reconstruction.

However, numerical reconstruction is reproducing light waves based on a plane at a particular distance from a hologram plane, and thus, if a position of a plane is not a position of an object, accurate object information cannot be known due to diffraction of light waves.

Here, a distance from a hologram plane to an object is called an in-focus distance of a reproduction image.

In order to extract an in-focus distance, in the related art, a search section is set in advance by guessing an in-focus distance roughly, and the search section is uniformly subdivided at a predetermined resolution, and numerical reconstruction is performed by sequentially changing the distance in the uniformed subdivided search section, and clearness of an obtained reconstructed image is measured to finally determine an in-focus distance.

The biggest shortcomings of the existing in-focus distance extraction lie in that an extraction speed is very low because a series of numerical reconstruction processes is performed.

Also, if a previous guess of the search section for an in-focus distance is erroneous, an extraction speed is further slowed due to repeated section re-setting and corresponding numerical reconstructions.

Without prior information regarding an object, a possibility of erroneously estimating a distance section may increase.

When an in-focus distance of a given hologram is extracted, information of a recorded object may be accurately recognized and may be used as essential information during a hologram editing process such as composition.

### SUMMARY

Accordingly, the present invention provides an apparatus and method for estimating a position of an object recorded in a hologram at a high speed using only light wave information recorded in the hologram.

In one general aspect, an apparatus for estimating a position of a hologram object includes: a local spatial frequency calculating unit configured to calculate a local spatial frequency on a plane based on input hologram data; and a light ray focal point calculating unit configured to calculate a focal point on which light rays starting from the hologram plane converge using the local spatial frequency calculated by the local spatial frequency calculating unit, to estimate a position of an object.

The local spatial frequency calculating unit calculates the local spatial frequency of light waves recorded in the hologram data using windowed Fourier transform.

The local spatial frequency calculating unit may calculate the local spatial frequency using windowed Fourier transform expressed as Equation (3) below.

S_{g}(α,β;x₀,y₀)=∫∫g₁(x,y;x₀,y₀)exp(−j2π(αx+βy))dxdy (3)

where S_{g} is windowed Fourier transform, α and β are spatial frequencies, and x₀ and y₀ are particular positions of a hologram and g₁ is a localization of the input light wave.

The local spatial frequency may be determined as the maximum point for the square of a magnitude of the windowed Fourier transform.

The light ray focal point calculating unit may calculate the focal point on which the light rays converge using a least square method.

In another general aspect, a method for estimating a position of a hologram object includes: receiving hologram data; calculating a local spatial frequency on a hologram plane based on the received hologram data; and calculating a focal point on which light rays starting from the hologram plane converge using the local spatial frequency to estimate a position of an object.

In the calculating of a local spatial frequency, the local spatial frequency of light waves recorded in the hologram data may be calculated using windowed Fourier transform.

The windowed Fourier transform may be performed using Equation 3 below.

S_{g}(α,β;x₀,y₀)=∫∫g₁(x,y;x₀,y₀)exp(−j2π(αx+βy))dxdy (3)

Wherein, S_{g} is the windowed Fourier transform, α and β are spatial frequencies, and x₀ and y₀ are particular positions of a hologram, and g₁ is a localization of the input light wave.

The local spatial frequency may be determined as the maximum point for the square of a magnitude of the windowed Fourier transform.

In the estimating of a position of an object, the focal point on which the light rays converge may be calculated using a least square method.

### BRIEF DESCRIPTION OF THE DRAWINGS

FIG. 1 is a block diagram illustrating a configuration of an apparatus for estimating a position of a hologram object according to an embodiment of the present invention.

FIG. 2 is a flow chart illustrating an estimating method using an apparatus for estimating a position of a hologram object according to an embodiment of the present invention.

FIG. 3 is a view illustrating a state in which a local spatial frequency is formed in a hologram according to a phase distribution of object waves.

FIG. 4 is a view illustrating an image of object waves determined according to directions of rays of object waves determined by a local spatial frequency.

### DETAILED DESCRIPTION OF EMBODIMENTS

Hereinafter, embodiments of the present invention will be described in detail to be easily embodied by those skilled in the art with reference to the accompanying drawings. In the drawings, the sizes or shapes of elements may be exaggeratedly illustrated for clarity and convenience of description. Moreover, the terms used henceforth have been defined in consideration of the functions of the present invention, and may be altered according to the intent of a user or operator, or conventional practice. Therefore, the terms should be defined on the basis of the entire content of this specification.

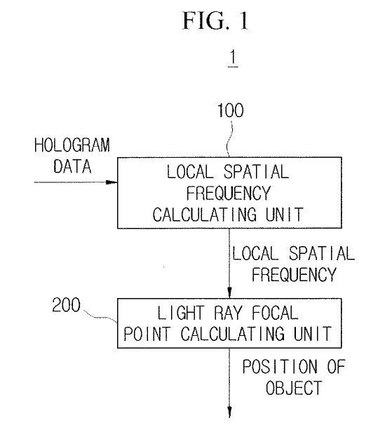

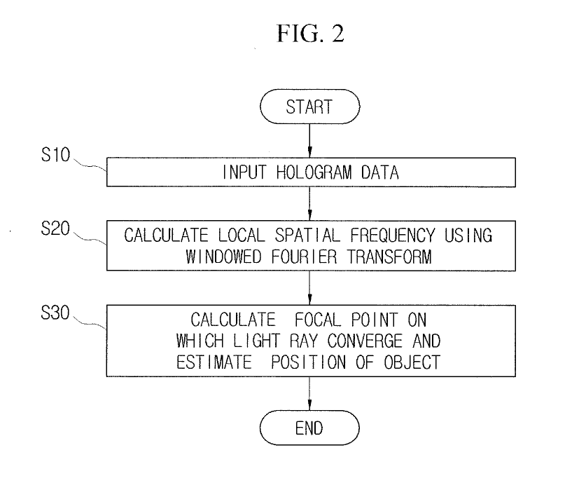

FIG. 1 is a block diagram illustrating a configuration of an apparatus for estimating a position of a hologram object according to an embodiment of the present invention, and FIG. 2 is a flow chart illustrating an estimating method using an apparatus for estimating a position of a hologram object according to an embodiment of the present invention.

Referring to FIGS. 1 and 2, an apparatus for estimating a position of a hologram object (or a hologram object position estimating apparatus) 1 includes a local spatial frequency calculating unit 100 and a light ray focal point calculating unit 200.

When hologram data is input in step S10, the local spatial frequency calculating unit 100 calculates a local spatial frequency on a hologram plane based on the input hologram data in step S20.

Here, the local spatial frequency, the spatial derivative of the phase of the light wave on the hologram plane, may be used for analyzing a local analysis of light waves.

Local spatial frequencies (α, β) on a hologram plane relate to phase information Φ of an object wave and are determined by Equation (1) below.

$$α = \frac{1}{2 π} \frac{\partial φ}{\partial x} , β = \frac{1}{2 π} \frac{\partial φ}{\partial y} \qquad ( 1 )$$

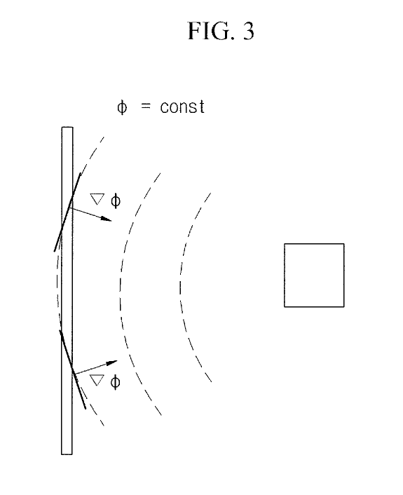

The local spatial frequencies and the phase distribution of the object wave will be described in detail with reference to FIG. 3. Local spatial frequencies are identical to hologram planar components of nomals to the a phase distribution, and wavefront information of object waves recorded in the hologram or light ray information may be known using the local spatial frequencies.

Here, when the local spatial frequencies are α and β and the wavelength is λ, the ray direction may be expressed as Equation (2) below.

(λα,λβ,\sqrt{1−(λα)²−(λβ)²} (2)

In order to numerically calculate a local spatial frequency, phase information of an object wave needs to be known. In this case, in order to accurately calculate phase information of an object wave, generally, a phase retrieval algorithm may be applied.

However, the phase retrieval algorithm is highly likely to include an error, and even if phase retrieval is made without an error, an error according to resolution of a hologram plane may not be avoided in calculating a derivatives of the phase, and as the distance to an object is increased, errors are increased.

Thus, in the present invention, windowed Fourier transform is used for numerical calculation of a local spatial frequency.

When a signal g and a window function h are expressed as g₁(x,y;x₀,y₀):=h(x−x₀,y−y₀)g(x,y), a windowedFourier transform S_{g} of the signal g may be defined to be expressed as Equation 3 below.

S_{g}(α,β;x₀,y₀)=∫∫g₁(x,y;x₀,y₀)exp(−j2π(αx+βy))dxdy (3)

Here, the windowed Fourier transform S_{g} may be understood as Fourier transform with respect to a local approximate of the signal g at a particular position (x₀, y₀) of the hologram.

A local spatial frequency intended to be calculated may be determined by selecting the maximum point for the square of a magnitude of windowed Fourier transform.

Thus, the use of windowed Fourier transform allows for calculation of a local spatial frequency with a high degree of accuracy, while being less affected by spatial resolution of a hologram.

The light ray focal point calculating unit 200 estimates a position of an object by calculating the position on which light wave light rays converge in step S30.

First, it is assumed that Xᵢ=(xᵢ, yᵢ, zᵢ)(i=1, . . . , n) are points on the hologram plane and dᵢ=(αᵢ, βᵢ, γᵢ) is the light ray direction for Xᵢ.

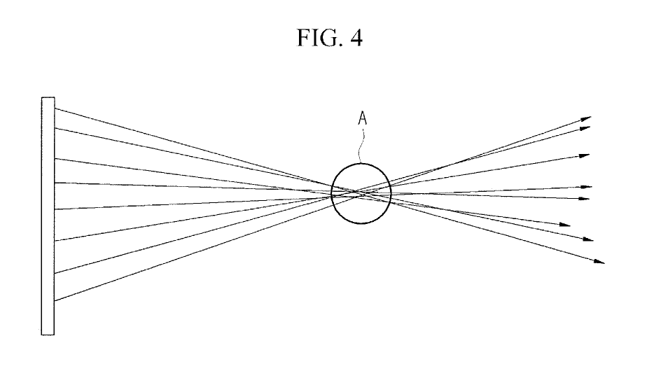

Then, as illustrated in FIG. 4, the area A on which light rays converge is understood as an area in which light waves reproduced from the hologram forms an image.

In the present invention, a focal point on which the light rays converge is obtained using a least square method. An energy function E over the given light rays is defined to be expressed as Equation (4) below.

$$E ( x ) = {\sum }_{i = 1}^{n} ( {‖ x - {x}_{i} ‖}^{2} - {〈 x - {x}_{i} , {d}_{i} 〉}^{2} ) \qquad ( 4 )$$

Wherein, [symbol] x−xᵢ, dᵢ [symbol] is an inner product of the vector.

The defined energy function E is the sum of the square of a distance from a particular position to the light rays, and when a position at which the energy function E is minimized is searched, a focal point on which the light rays converge may be calculated. The position is given by solving ∇E=0 and the focal point may be obtained by solving a determinant Aₓ=b.

Here, the matrix A and the matrix b may be expressed as Equation (5) below.

$$A = [ \begin{matrix}n - \sum {α}_{i}^{2} & - \sum {α}_{i} {β}_{i} & - \sum {α}_{i} {γ}_{i} \\ - \sum {α}_{i} {β}_{i} & n - \sum {β}_{i}^{2} & - \sum {β}_{i} {γ}_{i} \\ - \sum {α}_{i} {γ}_{i} & - \sum {β}_{i} {γ}_{i} & n - \sum {γ}_{i}^{2}\end{matrix} ] \\ b = [ \begin{matrix}\sum ( {x}_{i} - {x}_{i} {α}_{i}^{2} - {y}_{i} {α}_{i} {β}_{i} - {z}_{i} {α}_{i} {γ}_{i} ) \\ \sum ( {y}_{i} - {x}_{i} {α}_{i} {β}_{i} - {y}_{i} {β}_{i}^{2} - {z}_{i} {β}_{i} {γ}_{i} ) \\ \sum ( {z}_{i} - {x}_{i} {α}_{i} {γ}_{i} - {y}_{i} {β}_{i} {γ}_{i} - {z}_{i} {γ}_{i}^{2} )\end{matrix} ] \qquad ( 5 )$$

Unless at least two light rays are not parallel, an inverse matrix of the matrix A exists, and thus, in a general case, a solution may be calculated all the time.

As described above, according to embodiments of the present invention, a spatial frequency of a light wave recorded in a hologram may be calculated with a high degree of accuracy through windowed Fourier transform without a phase retrieval process.

Also, a focal point on which the light rays obtained using a calculated spatial frequency converge is calculated to search for a position of an object, whereby a position of an object recorded in the hologram may be estimated at a high speed without performing an existing array of numeral retrieval process and an image analysis process.

According to the embodiments of the present invention, a spatial frequency of a light wave recorded in a hologram may be calculated with a high degree of accuracy through a windowed Fourier transform without performing a phase retrieval process.

In addition, a position of an object may be searched by calculating a focal point on which a light ray aggregation converges on a hologram plane obtained using a calculated local spatial frequency by a least square method, whereby a position of an object recorded in a hologram may be estimated at a high speed without performing an existing array of numerical reconstruction process and image analysis process.

The apparatus and method for estimating a position of a hologram object has been described according to the embodiments, but the scope of the present invention is not limited to a specific embodiment. The present invention may be corrected and modified within the technical scope obvious to those skilled in the art.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for estimating a position of a hologram object, the apparatus comprising:
a local spatial frequency calculating unit configured to calculate a local spatial frequency on a plane based on input hologram data; and
a light ray focal point calculating unit configured to calculate a focal point on which light rays starting from hologram plane converge using the local spatial frequency calculated by the local spatial frequency calculating unit, to estimate a position of an object.

2. The apparatus of claim 1, wherein the local spatial frequency calculating unit calculates the local spatial frequency of light waves recorded in the hologram data using windowed Fourier transform.

3. The apparatus of claim 2, wherein the local spatial frequency calculating unit calculates the local spatial frequency using Fourier transform expressed as Equation below;
S_{g}(α,β;x₀,y₀)=∫∫g₁(x,y;x₀,y₀)exp(−j2π(αx+βy))dxdy
Wherein, S_{g} is windowed Fourier transform, α and β are spatial frequencies, and x₀ and y₀ are particular positions of a hologram, and g₁ is a localization of the input light wave.

4. The apparatus of claim 2, wherein the local spatial frequency is determined as a maximum point for the square of a magnitude of the windowed Fourier transform.

5. The apparatus of claim 1, wherein the light ray focal point calculating unit calculates the focal point on which the light rays converge using a least square method.

6. A method for estimating a position of a hologram object, the method comprising:
receiving hologram data;
calculating a local spatial frequency on a hologram plane based on the received hologram data; and
calculating a focal point on which light rays starting from the hologram plane converges using the local spatial frequency to estimate a position of an object.

7. The method of claim 6, wherein, in the calculating of a local spatial frequency, the local spatial frequency of light waves recorded in the hologram data is calculated using windowed Fourier transform.

8. The method of claim 7, wherein the windowed Fourier transform is performed using Equation below;
S_{g}(α,β;x₀,y₀)=∫∫g₁(x,y;x₀,y₀)exp(−j2π(αx+βy))dxdy
Wherein, S_{g} is windowed Fourier transform, α and β are spatial frequencies, and x₀ and y₀ are particular positions of a hologram, and g₁ is a localization of the input light wave.

9. The method of claim 7, wherein the local spatial frequency is determined as a maximum point for the square of a magnitude of the windowed Fourier transform.

10. The method of claim 6, wherein, in the estimating of a position of an object, the focal point on which the light rays converge is calculated using a least square method.
